(19) United States
(12) Patent Application Publication
(10) Pub. No.: US 2015/0010428 A1
(43) Pub. Date: Jan. 8, 2015

(54) ALLOY

(71) Applicant: ROLLS-ROYCE PLC, London (GB)

(72) Inventors: Mark Christopher HARDY, Belper (GB); David DYE, London (GB); Huiyu YAN, London (GB); Matthias KNOP, London (GB); Howard James STONE, Cambridge (GB)

(21) Appl. No.: 14/314,539

(22) Filed: Jun. 25, 2014

(30) Foreign Application Priority Data
Jul. 4, 2013 (GB) 1312000.1

(51) Int. Cl. C22C 19/07; C22C 30/00

(52) U.S. Cl. CPC C22C 19/07; C22C 30/00; F05C 2201/0463; F05C 2201/0466
USPC 420/586; 420/588

(57) ABSTRACT

A cobalt-nickel alloy composition comprising by weight: about 29 to 37 percent cobalt; about 29 to 37 percent nickel; about 10 to 16 percent chromium; about 4 to 6 percent aluminium; at least one of Nb, Ti and Ta; at least one of W, Ta and Nb; the cobalt and nickel being present in a ratio between about 0.9 and 1.1.

### TECHNICAL FIELD OF INVENTION

The invention relates to alloys suitable for high temperature applications and particularly cobalt/nickel alloys that may be used to manufacture components in a gas turbine engine.

### BACKGROUND OF INVENTION

Certain portions of a gas turbine engine are expected to operate for extended periods of time at temperatures above 700° C. and to peak temperatures of 800° C. or more. The components operating within these portions, such as e.g. disc rotors, aerofoils or casings, are often under high stress caused by rotational, pressure or other forces.

There is a requirement to provide improved alloys that extend temperature capability or the number of operating cycles and operation time for components within difficult conditions in order to provide an affordable service life.

It is an object of the present invention to seek to provide an improved alloy.

### STATEMENTS OF INVENTION

According to a first aspect of the invention there is provided a cobalt-nickel alloy composition comprising by weight (wt): 29.2 to 37 percent cobalt (Co); 29.2 to 37 percent nickel (Ni); about 10 to 16 percent chromium (Cr); about 4 to 6 percent aluminium (Al); at least one of niobium (Nb), titanium (Ti) and tantalum (Ta); at least one of tungsten (W), Ta and Nb; the Co and Ni being present in a ratio between about 0.9 and 1.1.

Preferably the Co and Ni are present in the ratio between 0.95 and 1.05.

The alloy may comprise 30 to 36 wt % Co.

The alloy may comprise 30 to 36 wt % Ni.

The alloy may comprise t5 to 10 wt % W and preferably between 9 to 10 wt % W, or 6 to 6.5 wt % W.

The alloy may comprise 3.9 to 5.2 wt % Al and preferably 3.9 to 4.8 wt % Al.

The alloy may comprise silicon (Si) in an amount up to 0.6 wt % of the alloy.

The alloy may comprise manganese (Mn) in an amount up to 0.6 wt % of the alloy.

The alloy may comprise Ti in an amount up to 1.0 wt % of the alloy.

The alloy may comprise Nb in an amount up to 1.8 wt % of the alloy.

The alloy may comprise hafnium (Hf) in an amount up to 0.5 wt % of the alloy.

The alloy may comprise carbon (C) in an amount from 0.02 to 0.04 wt % of the alloy.

The alloy may comprise boron (B) in an amount from 0.015 to 0.035 wt % of the alloy.

The alloy may comprise zirconium (Zr) in an amount from 0.04 to 0.07 wt % of the alloy.

The alloy may comprise iron (Fe) in an amount up to 8 wt % of the alloy.

The alloy may comprise tantalum (Ta in an amount about 2.9 to 4.0 wt % of the alloy.

The alloy may be formed from a powder of the elemental constituents, produced by argon gas atomisation.

### BRIEF DESCRIPTION OF DRAWINGS

Table 1 details the weight percent of a number of exemplary alloys listed as Alloy A to Alloy E.

Table 2 details the density in g/cm³ and an estimate of γ′ volume fraction of each of the alloys A to E.

FIG. 1 depicts a secondary electron image of etched Alloy A sample after heat treatment.

### DETAILED DESCRIPTION OF INVENTION

Metallic alloys are compositions comprising a mixture of metallic elements. Subjecting some Ni containing alloys to specific heat treatments or other processing steps permits precipitation strengthening by the formation of gamma prime (γ′) precipitates. Cobalt-nickel alloys containing Al and W can be precipitation strengthened by the ordered L1₂Co₃(Al,W)γ′ precipitates as well as the Ni₃Alγ′ precipitates that are found in conventional Ni base superalloys.

The ordered L1₂γ′ phase of Co is denser than an unordered Co matrix such that the precipitation of the γ′ phase increases the density of the alloy whilst the high temperature strength and temperature capability is improved. The density of the alloy has an engine weight penalty that offsets the improved temperature capability of the alloy.

By contrast the ordered L1₂γ′ phase of nickel is less dense than the matrix Ni, which permits a virtuous circle in Ni based superalloys such that an increase in γ′ content results in a reduction in alloy density whilst simultaneously increasing the temperature and capability and strength of the alloy.

Where Ni and Co are present in atomic percent (at %) or wt % ratios of around 1, a density increase from the formation of the L1₂γ′ phase of Co is offset by a density reduction of the ordered L1₂γ′ phase of Ni particularly where the γ′ has a continuous phase field between Ni₃Al,X (where X=Ti, Ta, Nb) and Co₃Al,Z (where Z=W, Ta, Nb).

Table 1 details the weight percent of a number of exemplary alloys listed as Alloy A to Alloy D. All of the alloys contain Co, Ni, Cr, W, Al, Ta, C, B and Zr and selected alloys have one or more of Ti, Fe, Si, Mn, and Nb. The density in g/cm³ and an estimate of γ′ volume fraction of each of the alloys is detailed in Table 2. The estimated volume fraction of γ′ is at ambient temperature.

The Co—Al—Z alloy has a face centred cubic (FCC) structure in the γ matrix and L1₂γ′ phase whilst Cr has a body centred cubic (BCC) structure. An excessive amount of Cr in the Co—Al—Z base alloy can destabilise the γ/γ′ microstructure. Advantageously, Ni substitutions for Co have been found to stabilise the γ′ phase and increase the size of the phase field and improve the stability of the alloy.

To provide sufficient Al in the alloy to permit formation of the Ni₃Alγ′ phase the quantity of Al in the alloy is greater than 3.9 wt % but preferably less than 5.2 wt %. Aluminium is also soluble in the γ matrix of the Co₃(Al, W) matrix and lower levels do not leave sufficient to form the γ′ phase with the Ni and thereby allow the virtuous circle which offsets the higher density Co₃(Al, W) matrix.

It has been found beneficial to provide similar at % levels of Ni and Co as this enables the maximum solid solution strengthening of the γ matrix. A proportion of W added to the alloy partitions to the γ phase and is an effective source of solid strengthening of the γ matrix. Preferably the level of W in the alloy is between 6 and 9.5 wt %.

Significant Ta, Ti and Nb contents are possible in the alloys, up to a combined 3 at % or 5.5 wt % which can partially substitute for W in the Co₃(Al, W) matrix. The Ta increases the γ′ solvus temperature when replacing W in the Co₃(Al, W) matrix. As the temperature capability of the alloy is partially determined by the solvus temperature, advantageously keeping the solvus temperature above a threshold increases the number of high temperature applications for which the alloy may be used.

Substituting W for Ta and Nb can result in further reductions in the alloy density. Tungsten also has a tendency to form acidic oxides that are detrimental to hot corrosion resistance. Reducing the amount of W in the alloy to below 10 wt % is understood to improve resistance to type II hot corrosion damage. Tungsten is also cheaper than Ta so reducing the amount of Ta reduces the cost of the alloy.

Tantalum is preferably used within the range 2.9 to 4.0 wt % but more preferably within the range 2.9 to 3.3 wt %.

The levels of Ti are kept below 1 wt % due to its propensity to diffuse to exposed surfaces to form rutile (TiO₂), which is a porous and non-protective scale. Higher levels of Ti can reduce the alloys resistance to oxidation damage. The addition of Ti produces unstable primary MC carbide, which will transform to Cr containing M₂₃C₆ carbides that precipitate on grain boundaries on exposure to temperatures between 800 and 900° C. It is understood that a limited precipitation of small M₂₃C₆ carbide particles is beneficial for minimising grain boundary sliding during periods of sustained loading at elevated temperature.

The amount of Nb is limited to below 1.8 wt % to avoid formation of delta (δ) phase.

The low γ′ solvus temperatures of the Co₃(Al, Z)γ′ strengthened alloys and the low rate of diffusion of W in Co enables precipitation of small γ′ particles that are typically less than 50 nm in size during quenching from a temperature above the γ′ solvus temperature.

To investigate the phase stability of these alloys, 50 g finger-shaped polycrystalline ingots were produced by vacuum arc melting under a back-filled argon atmosphere. Cobalt-10W (at %) and Co-20W (at %) master alloys were used along with high-purity elemental pellets of 99.99% Cr; 99.97% Ni; 99.9% Al, Ti, Ta and Si; 99.8% Co; and 99.0% Fe. The as-cast ingots were then vacuum solution heat-treated at 1300° C. for 24 hours. Subsequently, the ingots were encapsulated in rectilinear mild steel cans with Ti powder packing material and hot rolled above the γ′ solvus temperature at 1150° C. to a sample thickness of 3-6 mm. A NETZSCH Jupiter differential scanning calorimeter (DSC) was then employed to determine the solvus temperature at a 10° C./minute scan rate under argon atmosphere. The alloys were aged at 80-100° C. below the γ′ solvus temperature. For all the ageing heat treatments, the alloys were sealed in quartz tubes which were back-filled with argon after evacuation. On completion of the heat treatment, the alloys were allowed to cool in the furnace.

Alloy compositions were measured using Inductively Coupled Plasma-Optical Emission Spectroscopy (ICP-OES) and density measurements were performed according to ASTM B311-08 at room temperature.

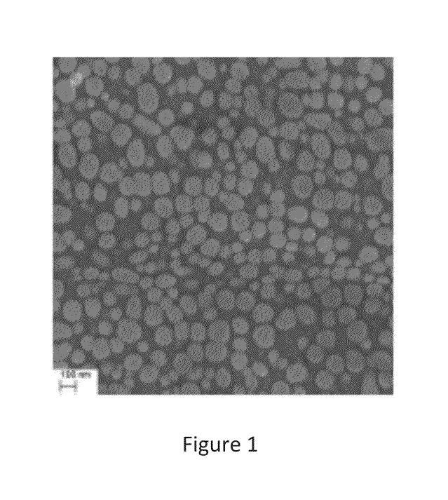

The microstructure of the alloy was examined using the LEO1525 field emission gun scanning electron microscope (FEG-SEM) in the secondary electron imaging mode. Secondary phase compositions were measured using energy dispersive X-ray spectroscopy (EDX). The samples were ground, polished and electro-etched in a solution of 2.5% phosphoric acid in methanol at 2.5 V at room temperature for few seconds. A secondary electron image of Alloy A (Table 1) after etching is provided in FIG. 1.

Since the volume fraction of the γ′ is high, the spacing between the small particles is even smaller, which ensures that any dislocations tend to cut or shear through the particles rather than pass around them. The difficult passage of dislocations through the particles gives rise to a very high yield stress value for the alloys.

The refractory content of the γ′ phase minimises the coarsening of the precipitate particles during ageing heat treatment and high temperature exposure of the alloy in use due, in part, to the low rates of diffusion of the refractory elements within the alloy. Accordingly, the alloys exhibit excellent resistance to creep strain accumulation and resistance to fatigue crack nucleation. A high resistance to dwell crack growth is required for safety critical applications such as use in a disc rotor.

The alloys A to D are suitable for use at temperatures of 800° C. At these temperatures a dense and protective chromia scale provides resistance to oxidation and hot corrosion damage in the cobalt-nickel base alloys. The level of Cr in the alloys is therefore preferably above 10 wt % and between 10 and 15 wt % a value of between 13 and 14 wt % has been found to offer good qualities in the alloy. As the Cr content is increased the γ/γ′ microstructure becomes less stable. At a Cr level of around 10 wt % to the base alloy the γ′ becomes rounded with an average γ′ of approximately 80 nm. The γ/γ′microstructure is still observed at 13 at % Cr, but increasing the level above 15 wt % results in the precipitation of undesirable secondary phases (CoAl and Co₃W), a discontinuous precipitation and an absence of cuboidal γ′. Excessive levels of Cr and too low levels of Ni result in alloys where the γ′ field shrinks or even disappears, resulting in the precipitation of the B2 (Co, Ni)Al and/or DO₁₉ Co₃W phases. These intermetallics result in alloys that are brittle and show poor oxidation resistance, and therefore the levels of Cr and Ni need to be carefully balanced to provide oxidation resistance and microstructural stability.

Limited amounts of Si and Mn can also be added to the alloy to produce thin films of silica and/or MnCr₂O₄ spinel beneath the chromia scale. These films improve the barrier to the diffusion of oxygen and thus the resistance to environmental damage. In the γ′ phase, the Si replaces Al whilst in the γ it substitutes for Cr. Values of Si below 0.6 wt % are required as at temperatures above 600° C. it has a tendency to partition to the γ and can promote the formation of sigma (σ) phase at grain boundaries during prolonged exposure at temperatures above 750° C. This topologically close packed phase is undesirable as it removes Cr from the γ matrix, thereby reducing environmental resistance, and reduces grain boundary strength. Where Mn is used, it replaces Ni and/or Co but partitions to the γ phase at temperatures above 500° C. and its presence in an amount of 0.6 wt % or less is preferred. Manganese, at levels of 0.2-0.6 wt.%, has been previously shown (U.S. Pat. No. 4,569,824) to improve corrosion resistance at temperatures between 650-760° C. and creep properties of polycrystalline Ni alloys, which contain 12-20 wt. % Cr.

Iron may be added to the alloy to reduce the cost. The presence of Fe has the beneficial effect of increasing the hardness of the alloy but at values above 20 wt % does have a tendency to destabilise the microstructure. Where Fe is present, it is preferred that it is provided in an amount that is less than 10 wt % and more preferably less than 8 wt %.

Although molybdenum (Mo) within the alloys may inhibit formation of the σ phase in the alloy and have a tendency to form acidic oxides in the alloy that are detrimental to hot corrosion resistance it has been found that this element preferentially partitions to the gamma phase and acts as a relatively slow diffusing heavy element within the gamma phase. This is advantageous for resistance to creep deformation and is due to the larger atomic size of Mo atoms compared to Ni or Co atoms. Mo is preferably included in an amount up to 5 wt % of the alloy and replaces a fraction of the W in the alloy, which partitions to both gamma and gamma prime phases in the ratio of approximately 1:3. However, as shown in Tables 1 and 2, the addition of Mo increases alloy density despite a reduction in the W content. A preferred method of manufacture for producing the alloys is to use powder metallurgy. Small powder particles, preferably less than 53 μm in size from inert gas atomisation, are consolidated in a steel container using hot isostatic pressing (HIP) at temperatures that are preferably above the γ′ solvus temperature of the alloy. For some components, it is possible to directly form the component from the HIP process. For other components, such as disc rotors, it is beneficial to take the HIP compacted article and subject it to extrusion to produce appropriately sized billets. Material from these billets can then be isothermally forged at low strain rates at temperatures that are preferably above the γ′ solvus temperature of the alloy.

The presence of Zr, B and C is beneficial in polycrystalline Ni or Co alloys as they are known to improve grain boundary strength. The use of powder metallurgy limits the size of carbide and boride particles, allows higher B levels without grain boundary liquation and enables the majority of carbides to reside at intragranular locations.

Carbide, oxide and oxy-carbide particles are present at the surfaces of powder particles after HIP. These particles form networks known as prior particle boundaries (PPBs). They remain after extrusion but are no longer in connected networks. However, they are able to provide a means to pin grain boundaries and control grain growth during forging above the γ′ solvus temperature of the alloy. Forging strains and strain rates are selected to achieve and an average grain size of 23 to 64 μm (ASTM 8 to 5) with isolated grains As Large As (ALA) 360 μm (ASTM 0) following forging or after subsequent solution heat treatment above the γ′ solvus temperature.

The advantage of powder metallurgy is that it gives rise to a coarse grain microstructure that improves damage tolerance, particularly under conditions in which oxidation and time dependent deformation influence fatigue crack growth resistance. Specific levels of B, Zr, Hf and, to a lesser extent, C have been added to optimise the resistance to high temperature deformation.

Hafnium may be added to the alloys in concentrations up to 0.5 wt %. The addition of Hf can improve the dwell crack growth resistance of the alloy as it has an affinity for sulphur (S) and oxygen (O₂) and scavenges these elements at grain boundaries. However, HfO₂ particles can be produced during melting, which need to be managed as these can limit the resistance of the alloy to fatigue crack nucleation. The use of Hf therefore needs to be balanced against the likely benefits for a particular alloy for a particular application.

It is preferred that the alloys are forged above the γ′ solvus temperature to minimise the flow stress for superplastic deformation. The required grain size can therefore be achieved without a super-solvus solution heat treatment after forging. As such, forgings can be furnace cooled after forging and then given a precipitation ageing heat treatment at temperatures of 80-100 below the γ′ solvus temperature for 4 to 24 hours. Furnace cooling after forging is beneficial as it produces very fine serrated grain boundaries around the γ′ particles. Such serrated grain boundaries are understood to improve the dwell crack growth resistance of the alloy as they inhibit grain boundary sliding, a form of creep damage.

The compositional ranges disclosed herein are inclusive and combinable, are inclusive of the endpoints and all intermediate values of the ranges). The modifier “about” used in connection with a quantity is inclusive of the stated value, and has the meaning dictated by context, (e.g., includes the degree of error associated with measurement of the particular quantity).

Weight percent levels are provided on the basis of the entire composition, unless otherwise specified. The terms “first,” and “second,” do not denote any order, quantity, or importance, but rather are used to distinguish one element from another. The terms “a” and “an” do not denote a limitation of quantity, but rather denote the presence of at least one of the referenced items. The suffix “s” is intended to include both the singular and the plural of the term that it modifies, thereby including one or more of that term (e.g. “the refractory element(s)” may include one or more refractory elements). Reference throughout the specification to “one example” or “an example”, etc., means that a particular element described in connection with the example is included in at least one example described herein, and may or may not be present in other examples.

1. A cobalt-nickel alloy composition comprising by weight (wt):
29.2 to 37 percent Co;
29.2 to 37 percent Ni;
10 to 16 percent Cr;
4 to 6 percent Al;
at least one of W, Nb, Ti and Ta;
the Co and Ni being present in a ratio between about 0.9 and 1.1.

2. An alloy according to claim 1, wherein the Co and Ni are present in the ratio between 0.95 and 1.05.

3. An alloy according to claim 1, wherein the alloy comprises 5 to 10 wt % W.

4. An alloy according to claim 3, wherein the alloy comprises 9 to 10 wt % W.

5. An alloy according to claim 3, wherein the alloy comprises 6 to 6.5 wt % W.

6. An alloy according to claim 3, wherein the alloy further comprises one or more of Si or Mn in a respective amount up to 0.6 wt % of the alloy.

7. An alloy according to claim 3, wherein the alloy comprises Ti in an amount up to 1.0 wt % of the alloy.

8. An alloy according to claim 3, wherein the alloy comprises Nb in an amount up to 1.8 wt % of the alloy.

9. An alloy according to claim 3, wherein the alloy comprises Mo in an amount up to 5 wt % of the alloy.

10. An alloy according to claim 3, wherein the alloy further comprises Hf in an amount up to 0.5 wt % of the alloy.

11. An alloy according to claim 3, wherein the alloy further comprises C in an amount from 0.02 to 0.04 wt % of the alloy.

12. An alloy according to claim 3, wherein the alloy further comprises B in an amount from 0.015 to 0.035 wt % of the alloy.

13. An alloy according to claim 3, wherein the alloy further comprises Zr in an amount from 0.04 to 0.07 wt % of the alloy.

14. An alloy according to claim 1, wherein the alloy further comprises Fe in an amount up to 8.0 wt % of the alloy.

15. An alloy according to claim 1, wherein the alloy further comprises Mo in an amount between 1.0 wt % and up to 5.0 wt % of the alloy.

16. An alloy according to claim 1, wherein the alloy comprises Ta in an amount about 2.9 to 4.0 wt % of the alloy.

17. A cobalt-nickel alloy composition comprising by weight (wt):
29.2 to 37 percent Co;
29.2 to 37 percent Ni;
10 to 16 percent Cr;
4 to 6 percent Al;
5 to 10 percent W;
1 to 5 percent Mo;
2.9 to 4 percent Ta;
0.02 to 0.04 percent C;
0.015 to 0.035 percent B;
0.04 to 0.07 percent Zr.

18. An alloy according to claim 15, wherein the alloy comprises 9 to 10 wt % W.

19. An alloy according to claim 15, wherein the alloy comprises 6 to 6.5 wt % W.

20. An alloy according to claim 15, wherein the alloy comprises 3.9 to 4.8 wt % Al.
